(19) United States
(12) Patent Application Publication
(10) Pub. No.: US 2017/0372679 A1
(43) Pub. Date: Dec. 28, 2017

(54) Mobile Terminal for Automatically Adjusting a Text Size and a Method Thereof

(71) Applicant: ULSee Inc., Taipei City (TW)

(72) Inventor: Zhou Ye, Foster City, CA (US)

(21) Appl. No.: 15/194,640

(22) Filed: Jun. 28, 2016

(51) Int. Cl. G09G 5/26; G06F 3/01; G06F 3/03

(52) U.S. Cl. CPC G09G 5/26; G06F 3/0304; G06F 3/013; G06F 2203/04806

(57) ABSTRACT

A mobile terminal for automatically adjusting a text size and a related method are provided. The mobile terminal includes a display screen, a 3D camera module, a motherboard, and a processor. The mobile terminal may be a mobile phone or a tablet. The display screen is used for displaying a text according to a text size. The 3D camera module is disposed on a top of the display screen, and is used for timely capturing a 3D image information of a human face of a user. The processor is disposed on the motherboard, and is used for calculating a distance between eyes of the user and the display screen according to the 3D image information of the human face of the user, and for timely adjusting the text size of the display screen according to the distance between the eyes of the user and the display screen.

### BACKGROUND OF THE INVENTION

### 1. Field of the Invention

The present disclosure relates to text adjustment, and more particularly to a mobile terminal for automatically adjusting a text size and a method thereof.

### 2. Description of the Prior Art

Currently mobile terminals (such as, a mobile phone or a tablet) have become indispensable communications tools of human life, and people often utilize the mobile phone or the tablet to make phone calls and send/receive messages. A text displayed on a display screen of the mobile phone or tablet is usually small, and thus nearsighted people and farsighted people need to wear glasses in order to clearly view the text displayed on the display screen of the mobile phone or tablet, which is very inconvenient for nearsighted people and farsighted people.

If nearsighted people and farsighted people do not wear glasses, it's difficult for them to operate the mobile phone or tablet for sending and receiving messages. Hence, how to make nearsighted people and farsighted people more convenient when they are operating the mobile phone or tablet has become an important topic for the person skilled in the art.

### SUMMARY OF THE INVENTION

With this in mind, it is one objective of the present disclosure to provide a mobile terminal for automatically adjusting a text size.

It is one objective of the present disclosure to provide a mobile terminal for automatically adjusting a text size according to diopters of eyes of a user.

It is one objective of the present disclosure to provide a method for automatically adjusting a text size of a mobile terminal.

According to one exemplary embodiment of the present disclosure, a mobile terminal for automatically adjusting a text size is provided. The mobile terminal includes:a display screen, a 3D camera module, a motherboard, and a processor. The display screen is used for displaying a text according to a text size. The 3D camera module is disposed on a top of the display screen, and is used for timely capturing a 3D image information of a human face of a user. The processor is disposed on the motherboard, and is used for calculating a distance between eyes of the user and the display screen according to the 3D image information of the human face of the user, and for timely adjusting the text size of the display screen according to the distance between the eyes of the user and the display screen.

According to another exemplary embodiment of the present disclosure, a method for automatically adjusting a text size of a mobile terminal is provided. The method includes the following steps: timely capturing a 3D image information of a human face of a user; calculating a distance between eyes of the user and the display screen according to the 3D image information of the human face of the user; timely adjusting a text size of the display screen according to the distance between the eyes of the user and the display screen; and displaying the text on the display screen according to the text size.

The mobile terminal for automatically adjusting a text size and related method provided in the present disclosure utilizes a 3D camera module to capture a 3D image information of a human face of a user and utilizes a processor to calculate a distance between eyes of the user and the display screen according to the 3D image information of the human face of the user, and then utilizes the processor to timely adjust the text size of the display screen according to the distance between the eyes of the user and the display screen. The mobile terminal and related method provided in the present disclosure is particularly suitable for nearsighted people, farsighted people and people with eye fatigue symptoms, which is more convenient for nearsighted people, farsighted people, and people with eye fatigue symptoms when they are operating a mobile phone or a tablet.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a front view diagram of a mobile terminal according to an example of the present disclosure.

FIG. 2 is a block diagram of a mobile terminal for automatically adjusting a text size according to an example of the present disclosure.

FIG. 3 is a flowchart illustrating the procedures of a method for automatically adjusting a text size of a mobile terminal according to an example of the present disclosure.

FIG. 4 is a diagram showing the display result by adopting a method for automatically adjusting a text size of a mobile terminal according to an example of the present disclosure.

FIG. 5 is a diagram showing feature points of a human face according to an example of the present disclosure.

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

The figures are only illustrations of an example, wherein the units or procedure shown in the figures are not necessarily essential for implementing the present disclosure. Those skilled in the art will understand that the units in the device in the example can be arranged in the device in the examples as described, or can be alternatively located in one or more devices different from that in the examples. The units in the examples described can be combined into one module or further divided into a plurality of sub-units.

A mobile terminal for automatically adjusting a text size and a related method are provided in the present disclosure. By adopting the mobile terminal and related method, the text size of the display screen of the mobile terminal may be automatically adjusted without increasing additional cost of the mobile terminal. This feature of the present disclosure may improve the functionality of the mobile terminal, which is particularly suitable for nearsighted people, farsighted people and people with eye fatigue symptoms. Therefore, it is more convenient for nearsighted people, farsighted people, and people with eye fatigue symptoms when they are operating a mobile phone or a tablet.

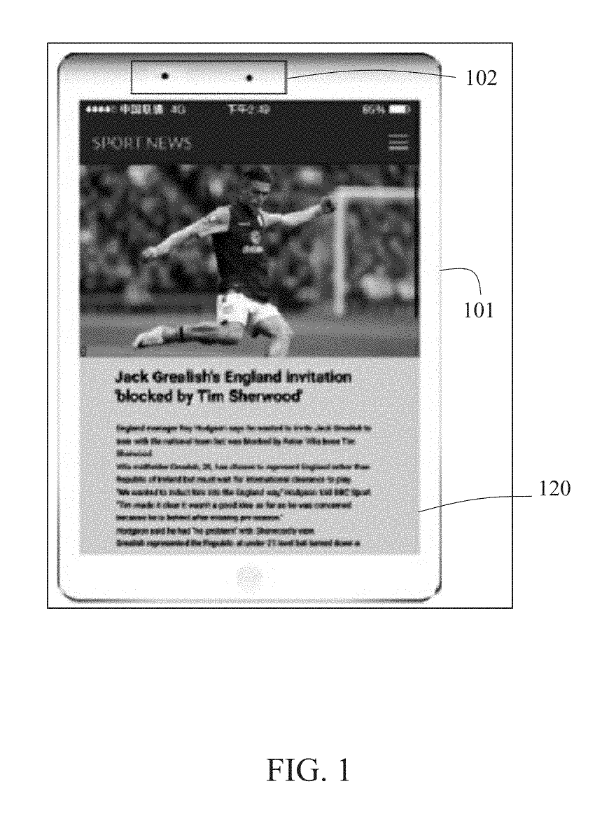

Please refer to FIG. 1. FIG. 1 is a front view diagram of a mobile terminal according to an example of the present disclosure. As shown in FIG. 1, a mobile terminal 101 may include a 3D camera module 102 and a display screen 120. The display screen 120 is used for displaying a text according to a text size. The 3D camera module 102 is disposed on a top of the display screen 120, and is used for timely capturing a 3D image information of a human face of a user.

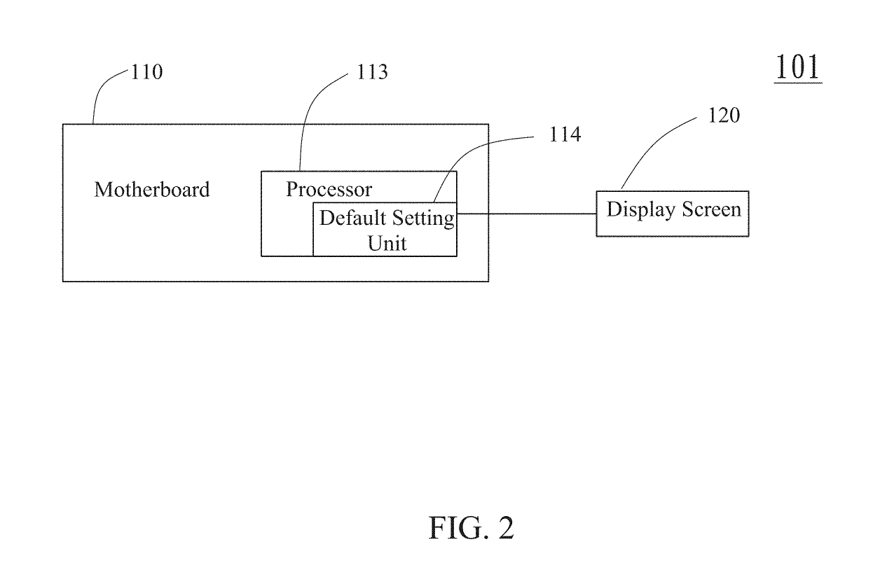

Please also refer to FIG. 2. FIG. 2 is a block diagram of a mobile terminal for automatically adjusting a text size according to an example of the present disclosure. As shown in FIG. 2, the mobile terminal 101 may further include a motherboard 110 and a processor 113, wherein the processor 113 is disposed on the motherboard 110. The processor 113 is used for calculating a distance between eyes of the user and the display screen 120 according to the 3D image information of the human face of the user, and for timely adjusting the text size of the display screen 120 according to the distance between the eyes of the user and the display screen 120. Assume that a default text size is set as 5 when a distance between eyes of the user and the display screen 120 is 25 cm. If the processor 113 determines that the distance between the eyes of the user and the display screen 120 is 25˜35 cm, the processor 113 will adjust the text size to 6 accordingly. If the processor 113 determines that the distance between the eyes of the user and the display screen 120 is 35˜45 cm, the processor 113 will adjust the text size to 7 accordingly. If the processor 113 determines that the distance between the eyes of the user and the display screen 120 is 45˜55 cm, the processor 113 will adjust the text size to 8 accordingly. If the distance between the eyes of the user and the display screen 120 is 15˜25 cm, the processor 113 will adjust the text size to 4 accordingly.

Be noted that, in order to meet different requirements, the processor 113 of the present disclosure may further include a default setting unit 114. The user may pre-set a text adjustment mode of the processor 113 through the default setting unit 114 before operating the mobile terminal 101. For example, different diopters of eyes may correspond to different text sizes. In an example, when the user is nearsighted with 0˜2.00 diopters, the corresponding text size is set to 6; when the user is nearsighted with 2.00˜4.00 diopters, the corresponding text size is set to 7; when the user is nearsighted with 4.00˜6.00 diopters, the corresponding text size is set to 8; when the user is nearsighted with 6.00˜8.00 diopters, the corresponding text size is set to 9; and when the user is nearsighted with more than 8.00 diopters, the corresponding text size is set to 10. In another example, when the user is farsighted with 0˜2.00 diopters, the corresponding text size is set to 6; when the user is farsighted with 2.00˜4.00 diopters, the corresponding text size is set to 5; and when the user is farsighted with more than 4.00 diopters, the corresponding text size is set to 4.

In another example of the present disclosure, the user may pre-set diopters of eyes through the default setting unit 114 in advance, and the processor 113 may determine the text adjustment mode of the processor 113 based on the diopters of eyes of the user and the distance between the eyes of the user and the display screen 120. For example, the default setting unit 114 may determine the text adjustment mode to be a short distance text zoom-in mode or a long distance text zoom-in mode. When the default setting unit 114 determines that the text adjustment mode of the processor 113 is the short distance text zoom-in mode, the processor 113 will zoom in the text of the display screen 120 in a first distance, wherein the first distance is smaller than a threshold distance, such as 25 cm. When the default setting unit 114 determines that the text adjustment mode of the processor 113 is the long distance text zoom-in mode, the processor 113 will zoom in the text of the display screen 120 in a second distance, wherein the second distance is greater than the threshold distance.

Be noted that, the processor 113 may adjust the text size of the display screen 120 based on the distance between the eyes of the user and the display screen 120 only, or the processor 13 may adjust the text size of the display screen 120 based on the diopters of eyes of the user only, or the processor 113 may adjust the text size of the display screen 120 based on both of them. The above are only preferred examples of the present disclosure is not intended to limit the present disclosure. In practice, display screens with different screen sizes may correspond to different default text sizes. For example, the default text size of a 5-inches display screen is set to 5, and the default text size of a 4-inches display screen is set to 4. In another example, different diopters of eyes may correspond to different text sizes.

In an example, the user may pre-set the text adjustment mode of the processor 113 as the short distance text zoom-in mode through the default setting unit 114 based on nearsighted people's requirements. In another example, the user may pre-set the text adjustment mode of the processor 113 as the long distance text zoom-in mode through the default setting unit 114 based on farsighted people's requirements. Hence, the mobile terminal provided in the present disclosure is suitable for the needs of different people, which can improve market competitiveness of mobile terminals.

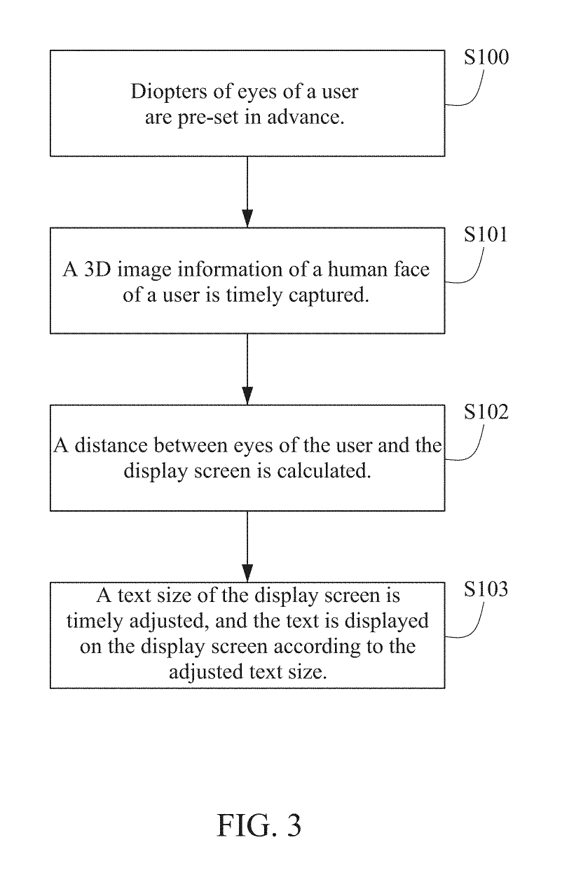

In accordance with the mobile terminal for automatically adjusting a text size of the present disclosure, an example of a method for automatically adjusting a text size of a mobile terminal is provided in the present disclosure. Please refer to FIG. 3. FIG. 3 is a flowchart illustrating the procedures of a method for automatically adjusting a text size of a mobile terminal according to an example of the present disclosure. The method may include the following steps.

At step S100, diopters of eyes of a user are pre-set in advance.

In a specific implementation, the user may pre-set diopters of eyes of the user through the default setting unit 114 in advance.

At step S101, a 3D image information of a human face of a user is timely captured.

In a specific implementation, the 3D camera module 102 may capture depth information of the human face of the user.

At step S102, a distance between eyes of the user and the display screen is calculated.

In an example, the processor 113 of the mobile terminal 101 calculates the distance between eyes of the user and the display screen 120 according to the depth information of the human face captured by the 3D camera module 102. In a specific implementation, the distance between eyes of the user and the display screen 120 is a straight-line distance from the user's eyes to the display screen 120.

At step S103, a text size of the display screen is timely adjusted, and the text is displayed on the display screen according to the adjusted text size.

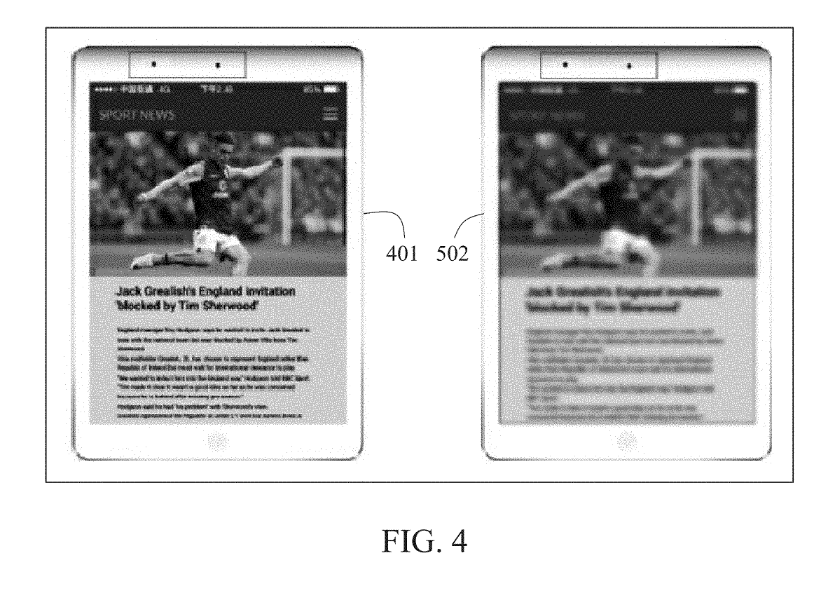

In an example, the processor 113 may timely adjust the text size of the display screen 120 according to the diopters of eyes of the user. In another example, the processor 113 may timely adjust the text size of the display screen 120 according to the distance between the eyes of the user and the display screen 120. In still another example, the processor 113 may timely adjust the text size of the display screen 120 according to both the diopters of eyes of the user and the distance between the eyes of the user and the display screen 120. After that, the text is displayed on the display screen 120 according to the adjusted text size. Therefore, the text size may be accordingly zoomed in or zoomed out according to the distance between the eyes of the user and the display screen 120, and the display result is shown in FIG. 4. FIG. 4 is a diagram showing the display result by adopting a method for automatically adjusting a text size of a mobile terminal according to an example of the present disclosure. As shown in the right part of FIG. 4, the display result 402 of the text displayed on the display screen is blurry before adopting the text adjustment method of the present disclosure. As shown in the left part of FIG. 4, the display result 401 of the same text displayed on the display screen becomes clearer after adopting the text adjustment method of the present disclosure.

In practice, the text adjustment mode of the processor 113 may be pre-set in advance in order to meet different people's requirements. For example, the diopters of eyes of the user may be pre-set through the default setting unit 114 in advance for determining the text adjustment mode of the processor 113, and thus the processor 113 may accordingly adjust the text size based on the determined text adjustment mode. In an example, the user may pre-set the text adjustment mode of the processor 113 as the short distance text zoom-in mode through the default setting unit 114 based on nearsighted people's requirements. In another example, the user may pre-set the text adjustment mode of the processor 113 as the long distance text zoom-in mode through the default setting unit 114 based on farsighted people's requirements. Hence, the mobile terminal provided in the present disclosure is suitable for the needs of different people.

Be noted that, the 3D camera module 102 of the present disclosure may adopt a 3D distance measurement technology, such as TOF (Time-Of-Flight), to irradiate Infrared lights to the human face of the user for calculating the distance between the eyes of the user and the 3D camera module 102. In another example of the present disclosure, a light coding may be adopted for estimating the distance between the eyes of the user and the 3D camera module 102. For example, known speckle patterns of Infrared lights may be projected to the human face of the user for calculating the depth information of objects, wherein light points of the known speckle patterns are pseudo-randomly distributed. In practice, the 3D camera module 102 of the present disclosure has been calibrated in factories, and thus projection positions of all of the light points of Infrared lights and their corresponding projection distances (calibrated projection distances) are already known. That is to say, an Infrared light point projection image with known projection distances is stored in the 3D camera module 102. When the human face of the user is located at a position of the space closer than the calibrated projection distance, the light points of Infrared lights will move in a first direction. On the other hand, if the human face of the user is located at a position of the space farer than the calibrated projection distance, the light points of Infrared lights will move in a second direction, wherein the second direction is opposite to the first direction. Since the 3D camera module 102 has been calibrated already, the projection positions of all of the light points of Infrared lights are known in advance. When one object is existed and located in a first distance (rather than the calibrated projection distances) of the space, the 3D camera module 102 may utilize offset distances of the light points of Infrared lights projected on the object to estimate the first distance between the object and the 3D camera module 102.

The above are merely examples for describing operations of the present disclosure, and is not intended to limit the present disclosure within the spirit and principles of the present disclosure. Any distance measurement technology using a camera module for measuring the distance in the protection of the present disclosure should contain within the range.

In one example of the present disclosure, the 3D camera module 102 may be used for recording a viewing time that the eyes of the user are viewing the display screen of the mobile terminal, and thus the processor 113 may alert the user by using a warning signal (such as, a warning sound or a warning message) according to the viewing time that the eyes of the user are viewing the display screen of the mobile terminal. In still another example of the present disclosure, the 3D camera module 102 may be used for capturing a posture information of the user, and thus the processor 113 may alert the user by using a warning signal (such as, a warning sound or a warning message) according to the posture information of the user. In still another example, the processor 113 may alert the user by using a warning signal (such as, a warning sound or a warning message) according to both the viewing time that the eyes of the user are viewing the display screen of the mobile terminal and the posture information of the user. In an example, when the 3D camera module 102 detects that the viewing time that the eyes of the user are viewing the display screen 120 of the mobile terminal 101 is greater than a threshold time, the processor 113 of the mobile terminal 101 may alter the user to take a break by using a warning sound or a warning message. The threshold time may be pre-set by the user, but this should not be a limitation of the present disclosure. In another example, when the 3D camera module 102 detects that the posture information of the user does not meet a reference posture, the processor 113 of the mobile terminal 101 may alter the user to change his/her posture by using a warning sound or a warning message.

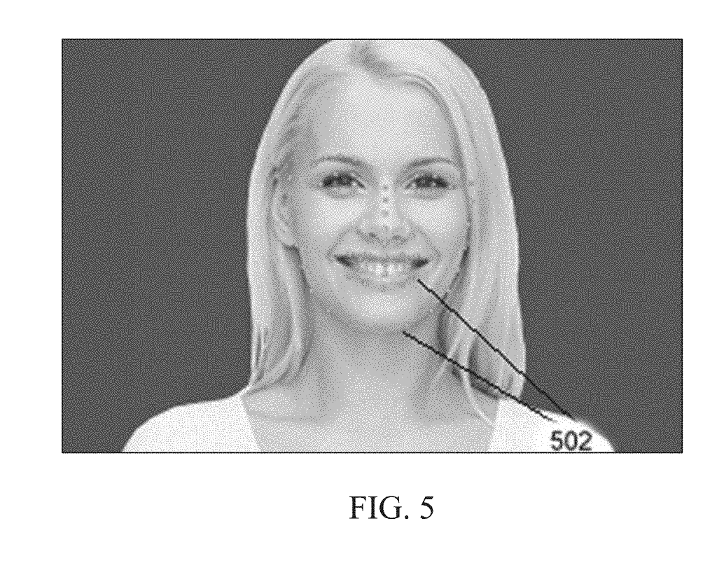

Be noted that, the 3D camera module 102 of the present disclosure may be used for timely capturing human face information of the user. Please refer to FIG. 5. FIG. 5 is a diagram showing feature points of a human face according to an example of the present disclosure. In this example, the processor 113 may dynamically and timely track the feature points of the human face of the user 502 for evaluating the posture information of the user, wherein points located at eyes, mouth, nose, apex of chin may be selected as the feature points of the human face of the user. The processor 113 may adopt a feature point positioning algorithm to perform fast and accurate positioning, and may display the positioning result on the image of the human face by dots, as is shown in FIG. 5. On the basis of the accurate positioning of the feature points of the human face, the processor 113 then calculates a rotation angle of the human face in the three-dimensional space for estimating a 3D posture information of the human face. In an example of the present disclosure, a coordinate origin of the image of the human face may be selected to be at a tip of the nose, and a center of left eye and a center of right eye may be selected as pupil positions, such that the processor 113 may utilize the feature points 502 of the human face to obtain the 3D posture information of the human face. Therefore, the processor 113 may alert the user by using a warning sound or a warning message according to the viewing time that the eyes of the user are viewing the display screen of the mobile terminal and/or the posture information of the user.

In summary, the mobile terminal for automatically adjusting a text size and related method provided in the present disclosure may utilize the 3D camera module 102 to capture the distance information between the eyes of the user and the display screen of the mobile terminal and utilize the processor to perform text adjustment for achieving the goal of automatically adjusting the text size of the display screen according to the distance between the eyes of the user and the display screen. The mobile terminal and related method provided in the present disclosure is particularly suitable for nearsighted people, farsighted people and people with eye fatigue symptoms, which is more convenient for nearsighted people, farsighted people, and people with eye fatigue symptoms when they are operating a mobile phone or a tablet.

Reference in the specification to “one example” or “an example” means that a particular feature, structure, or characteristic described in connection with the example is included in at least an implementation. The appearances of the phrase “in one example” in various places in the specification are not necessarily all referring to the same example. Thus, although examples have been described in language specific to structural features and/or methodological acts, it is to be understood that claimed subject matter may not be limited to the specific features or acts described. Rather, the specific features and acts are disclosed as sample forms of implementing the claimed subject matter.

The above are only preferred examples of the present disclosure is not intended to limit the present disclosure within the spirit and principles of the present disclosure, any changes made, equivalent replacement, or improvement in the protection of the present disclosure should contain within the range.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mobile terminal for automatically adjusting a text size, comprising:
a display screen, for displaying a text according to a text size;
a 3D camera module, disposed on a top of the display screen, for timely capturing a 3D image information of a human face of a user;
a motherboard; and
a processor, disposed on the motherboard, for calculating a distance between eyes of the user and the display screen according to the 3D image information of the human face of the user, and for timely adjusting the text size of the display screen according to the distance between the eyes of the user and the display screen.

2. The mobile terminal according to claim 1, wherein the 3D camera module is further used for recording a viewing time that the eyes of the user are viewing the display screen of the mobile terminal.

3. The mobile terminal according to claim 2, wherein the processor is further used for alerting the user by using a warning signal according to the viewing time that the eyes of the user are viewing the display screen of the mobile terminal.

4. The mobile terminal according to claim 1, wherein the 3D camera module is further used for capturing a posture information of the user.

5. The mobile terminal according to claim 4, wherein the processor is further used for alerting the user by using a warning signal according to the posture information of the user.

6. The mobile terminal according to claim 1, wherein the processor further comprises:
a default setting unit, for determining a text adjustment mode of the processor to be a short distance text zoom-in mode or a long distance text zoom-in mode;
wherein when the default setting unit determines that the text adjustment mode of the processor is the short distance text zoom-in mode, the processor will zoom in the text of the display screen in a first distance, and the first distance is smaller than a threshold distance; and when the default setting unit determines that the text adjustment mode of the processor is the long distance text zoom-in mode, the processor will zoom in the text of the display screen in a second distance, and the second distance is greater than the threshold distance.

7. The mobile terminal according to claim 6, wherein the default setting unit is further used for pre-setting diopters of the eyes of the user in advance, and the processor is further used for automatically adjusting the text size according to the diopters of the eyes of the user.

8. A method for automatically adjusting a text size of a mobile terminal, the mobile terminal comprising a display screen, the method comprising:
timely capturing a 3D image information of a human face of a user;
calculating a distance between eyes of the user and the display screen according to the 3D image information of the human face of the user;
timely adjusting a text size of the display screen according to the distance between the eyes of the user and the display screen; and
displaying the text on the display screen according to the text size.

9. The method according to claim 8, further comprising:
recording a viewing time that the eyes of the user are viewing the display screen of the mobile terminal.

10. The method according to claim 9, further comprising:
alerting the user by using a warning signal according to the viewing time that the eyes of the user are viewing the display screen of the mobile terminal.

11. The method according to claim 8, further comprising:
capturing a posture information of the user.

12. The method according to claim 11, further comprising:
alerting the user by using a warning signal according to the posture information of the user.

13. The method according to claim 8, further comprising:
determining a text adjustment mode of the processor to be a short distance text zoom-in mode or a long distance text zoom-in mode;
when determining that the text adjustment mode of the processor is the short distance text zoom-in mode, zooming in the text of the display screen in a first distance, wherein the first distance is smaller than a threshold distance; and
when determining that the text adjustment mode of the processor is the long distance text zoom-in mode, zooming in the text of the display screen in a second distance, wherein the second distance is greater than the threshold distance.

14. The method according to claim 13, further comprising:
pre-setting diopters of the eyes of the user in advance; and
automatically adjusting the text size according to the diopters of the eyes of the user.
